(19) United States
(12) Patent Application Publication
(10) Pub. No.: US 2026/0050330 A1
(43) Pub. Date: Feb. 19, 2026

(54) CREATION AND CERIFICATION OF MEMORY-BASED EXPERIENCES AND GENERATION OF PERSONALITY/CAPABILITY PROFILES THEREFROM

(71) Applicant: Reminisequence, Inc., Edgewater, MD (US)

(72) Inventor: Sean Geoffrey O'Sullivan, Edgewater, MD (US)

(21) Appl. No.: 19/300,670

(22) Filed: Aug. 15, 2025

Related U.S. Application Data
(60) Provisional application No. 63/683,073, filed on Aug. 14, 2024.

(51) Int. Cl. G06F 3/01; G06F 21/10; H04N 21/81

(52) U.S. Cl. CPC G06F 3/015; G06F 21/107; H04N 21/8146

(57) ABSTRACT

System and method in field of human resource management, leadership development, executive succession planning, organizational culture modeling, recruitment, talent management, and individual capability profiling. System integrates memory certification protocols with neurocognitive and emotional profiling, creating a multi-dimensional platform for individual and organizational development through verified autobiographical, observational, and interpersonal memory artifacts. Provides a legally defensible foundation for employment, promotion, and succession decisions, additionally enabling potential use in broader legal contexts such as law enforcement, insurance underwriting, and compliance audits.

### PRIORITY

This application claims the priority under 35 USC § 119 of U.S. Provisional Application 63/683,073 filed on Aug. 14, 2024. Application 63/683,073 is herein incorporated by reference in its entirety.

### BACKGROUND

Talent acquisition, succession, workforce planning, and development historically rely on retrospective interviews, behavioral assessments, psychometric testing, and static resumes. These methods fail to dynamically capture lived skills and leadership experiences and patterns, contextual judgment, personality-in-action, and real-world influence. There exists a need to capture and certify key role-based skills and leadership experiences, quantify personality and capability attributes, enable memory-based leadership and knowledge legacy transfer and culture continuity, reduce the ambiguity of hiring and succession decisions. Provide legally defensible support for employment-related decision-making.

### BRIEF DESCRIPTION OF FIGURES

The features and advantages of the various embodiments will become apparent from the following detailed description in which:

FIG. 1 illustrates a high-level block diagram of an example system, according to one embodiment.

FIG. 2 illustrates a high-level functional diagram of an example server utilized in an example system, according to one embodiment.

FIG. 3 illustrates a flow chart of an example process for capturing information related to an individual and their experience as it may relate to determining if they have the appropriate skills, competencies, innate traits, leadership experiences, emotional intelligence, problem-solving intelligence, judgment, collaboration, and developmental trajectory, according to one embodiment.

FIG. 4 illustrates flow chart of an example process for securely packaging the consolidated experience, securely storing the consolidated experience, creating ownership rights in the consolidated memory and controlling access thereto, according to one embodiment.

### DETAILED DESCRIPTION

A system is provided that can perform certain tasks including at least a subset of: (a) collect details about an individual regarding a human resources matter (e.g., applying for a job, promotion, or leadership position) including how the individual would handle certain situations and identifying any experiences that support their answer and/or exemplify they have the desired skills, competencies, innate traits, leadership, emotional intelligence, judgment, collaboration, and developmental trajectory required, (b) capture various biometric and neural inputs from the individual as they recount their answers and/or experience, (c) utilize artificial intelligence to compare the biometric and neural inputs to industry benchmarks, (d) gather additional information about the experience from public sources, if available, (e) integrate the public information with the collected details to create an immersive presentation of the experience, (f) validate the experience as being authenticate after at least some subset of a-e, (f) encrypt the authenticated immersive presentation, (e) store the encrypted immersive presentation, (f) record the creation of the authentic immersive presentation on an immutable or tamper-evident registry (e.g., the blockchain), (g) create a smart contract in the form of a digital asset for access to the authentic immersive presentations for possible future review.

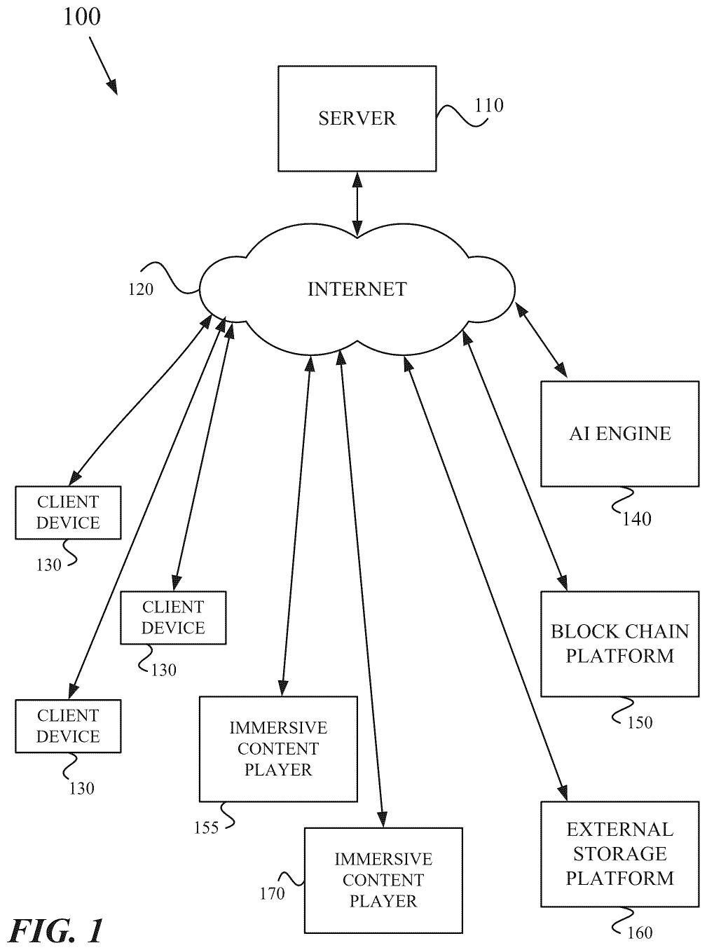

FIG. 1 illustrates a high-level block diagram of an example system 100. The system 100 includes a server 110 that communicates via the Internet 120 with client devices 130 (3 illustrated), an AI engine 140, a blockchain platform 150, an external storage platform 160 and immersive content players 170 (2 illustrated). The server 110 may be centralized or distributed. The server 110 is designed to communicate (e.g., via the Internet 120) with the client devices 130 in order to provide the users thereof the ability to capture answers to posed questions including information about their relevant experiences (e.g., individuals applying for leadership positions). The client devices 130 may be various Internet enabled devices including, but not limited to, wireless phones, tablets, laptops, desktops, and gaming systems. The client devices 130 may also capture, for example, neural data, biometrics and sensory metadata that is utilized to validate their answers including the information captured about the experience is authentic (is a Certified Experience). As ones experiences are a subset of ones memories it may be considered that a Certified Experience is a subset of a Certified Memory and when the term Certified Experience is utilized herein it also captures Certified Memory. The server 110 is configured to provide software as a service (SAAS) to the client devices 130.

The server 110 is also designed to communicate (e.g., via the Internet 120) with the AI engine 140 in order to perform operations using the AI engine 140 to gather additional information, context and/or details about the experiences captured by a client device 130. The AI engine 140 utilized may be a currently commercially available AI engine, which include, but are not limited to, CoPilot, ChatGPT, OpenAI, and MetaAI. According to one embodiment, the system 100 may include a specifically designed AI engine. The server 110 may provide the client device 130 with the additional information found about the captured experience in order to discuss potential conflicts. The server 110 may then utilize the AI engine 140 to create a consolidated experience that can be utilized to create an immersive presentation of the experience therefrom (immersive experience). The server 110 may provide the client device 130 with the immersive presentation so the user can either use the client device 130 or an immersive content player 170 to review the immersive presentation. The client device 130 or the immersive content player 170 may be utilized to capture, for example, neural data, biometrics, and sensory metadata of the individual during review to validate the immersive experience is authentic (is a Certified Experience).

The server 110 then encodes all of the information that makes up the immersive presentation into a unified experience payload package that is time stamped and content addressable via cryptographic hash (e.g., SHA-256) to ensure the authenticity of the data. The unified experience payload package may also be encrypted using, for example, an AES-256 or equivalent quantum-resistant algorithm (cryptographic key). The server 110 is also designed to communicate (e.g., via the Internet 120) with the external storage platform 160 and to provide the encrypted payloads thereto. The external storage platform 160 may be a decentralized, content-addressable file system (e.g., Arweave, IPFS, Filecoin), encrypted cloud storage, or a proprietary secure memory vault. Each unified experience payload package is stored immutably and indexed via its unique hash and the unified resource identifier (URI).

As used herein, an experience object (e.g., the unified experience payload package), whether certified or not certified, refers to any self-contained digital construct representing an authenticated, stored, and retrievable experience that was derived from an authenticated and thus certified memory, including, but not limited to, a unified experience payload package as described herein. An experience object may incorporate media, metadata, cryptographic identifiers, and associated access controls, and may be embodied in various storage and registry formats now known or hereafter developed.

The server 110 also communicates with the blockchain platform 150 in order to provide a ledger of the creation of the unified experience payload package. The blockchain platform 150 utilized may be a currently commercially available platform, which include, but are not limited to, Bitcoin, Ethereum, Solona, Coinbase and EOS. According to one embodiment, the system 100 may include a specifically designed blockchain platform. While in certain embodiments the registry of ownership and access is implemented using a blockchain or distributed ledger, alternative immutable or tamper-evident registry technologies, including but not limited to directed acyclic graph ledgers, quantum-secure distributed systems, federated consensus registries, trusted execution environment attestation logs, or other future-developed methodologies, are also contemplated herein.

The blockchain platform 150 (other disturbed ledger platform, immutable/tamper-evident registry technology) may also create a smart contract for the unified experience payload package that identifies, for example, ownership (e.g., potential employee providing information about their experience, employer, screening company), access permissions, replay restrictions and termination of the unified experience payload package. The blockchain platform 150 may mint a non-fungible token (NFT) for the unified experience payload package based on an immutable reference to the unified experience payload package (e.g., external storage platform universal resource identifier (URI)), metadata therefore and the smart contract logic. The metadata may include different parameters about the experience including, but not limited to, experience title, creator, timestamp, location, and signature hash. The NFT for experience objects (unified experience payload packages) may be referred to as a Neural Experience NFT (nxNFT) as it provides for immersive presentations of the experience. When discussed herein, the NFT for the experience objects may be referred to either as NFT or nxNFT (they may be utilized interchangeably). The term nxNFT as used herein further encompasses any successor, equivalent, or evolved digital asset form providing substantially similar functions for certified experience access, control, or transfer, regardless of underlying token standard or registry technology.

The server 110 may communicate with the individual, an HR representative, employer representative (e.g., hiring manager), or other interested parties to review the immersive presentation. The smart contract that is part of the NFT will define the associated parameters including who may review. The immersive experience may be reviewed using an immersive content player 170 and the sever 110 may communicate directly with the player 170 or via a client device 130. The immersive content player 170 may be a virtual reality (VR), augmented reality (AR) or mixed reality (MR) headset. Alternatively, the immersive content player 170 may be specialized displays and possibly software running on standard displays to create the immersive experience without the need for the headset. The immersive presentation may include different sensations in addition to vision, including but not limited to, touch, smell, moisture, and temperature. It is envisioned that in the future, the immersive content player 170 may provide direct-to-brain playback using various forms of contact and/or non-contact brain-machine interface technology, as well as other human-machine interface and interaction modalities, including, but not limited to, haptic, olfactory, thermal, and other sensory output systems.

As used herein, the term “human-machine interface” or “human-machine interaction” (collectively, HMI) refers to any hardware, software, firmware, or combination thereof that facilitates unidirectional or bidirectional or multidirectional communication, control, or sensory exchange between one or more human users and a computational or electromechanical system. HMI encompasses, without limitation, brain-machine interfaces (BMI), contact or non-contact neural interfaces, haptic feedback devices, olfactory and gustatory output systems, temperature and environmental control elements, gesture or motion tracking systems, wearable displays (including VR, AR, MR, and XR devices), audio output systems, and any future-developed modalities capable of conveying sensory input to or receiving control input from a human user.

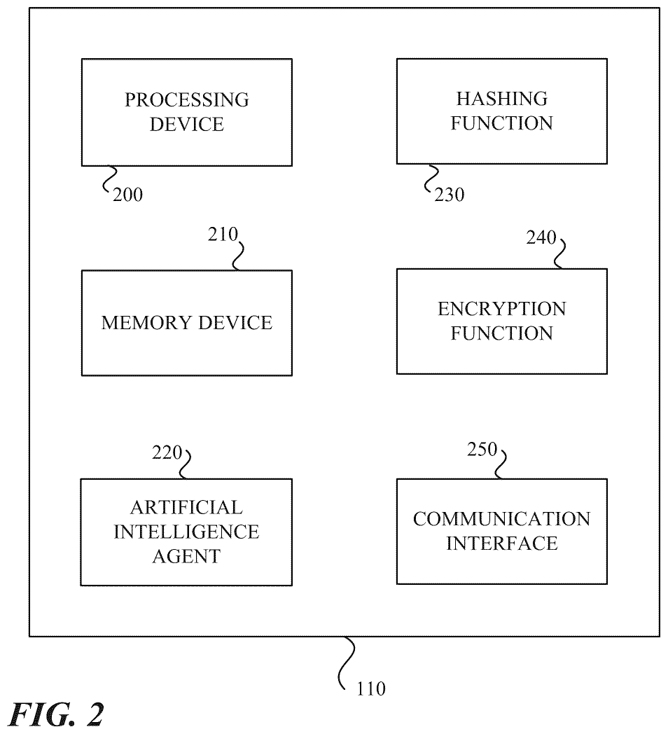

FIG. 2 illustrates a functional diagram of the server 110. The server 110 includes a processing device 200, a memory device 210, an artificial intelligence (AI) agent 220, a hashing function 230, an encryption function 240 and a communications interface 250. It should be noted that the various components are illustrated as single components (for ease of illustration) but are in no manner intended to be limited thereto. Rather, the server 110 may include a plurality of any or all of the various components. If a plurality of any of the components are utilized, the components may be the same or may be different. The server 110 may include other functional components that are not illustrated.

The processing device 200 may be one or more servers (e.g., web servers, database servers, mail servers, file servers or combinations thereof), computers, processors, or the like, or various combinations thereof. The processing device 200 controls the overall operation of the server 110. The memory device 210 may store data and processor readable instructions. The processing device 200 may read the processor readable instructions from the memory device 210. The processor readable instructions when executed by the processing device 200 cause the processing device 200 to perform different operations including at least a subset of tasks (a)-(g) discussed above and described in more detail later.

The AI agent 220 is designed to utilize the AI engine 150 to process large amounts of data, interpret the data, learn from the data, and provides responses based on information provided thereto. The information provided thereto includes information related to different experiences, biometrics and neural data collected and the data that is processed includes publicly available data related to the experience and associated personality traits associated with the biometrics and neural data. The AI agents 220 may also provide content generation.

The hashing function 230 is designed to cryptographically hash (e.g., SHA-256) the unified experience payload package. The cryptographic hash of the payload is utilized to validate the authenticity of the payload. The hashing function 230 may be provided by hardware or software. The encryption function 240 is designed to encrypt, using an AES-256 or similar quantum-resistant algorithm, the unified memory payload package so that it cannot be utilized without the decryption key. The encryption function 240 may be provided by hardware or software.

The communications interface 250 may enable communications between the server 110 and other systems and devices including the client devices 130, the AI engine 140, the blockchain platform 150, the external storage platform 160 and the immersive content players 170. The communications interface 130 may provide wired and/or wireless communications utilizing various protocols.

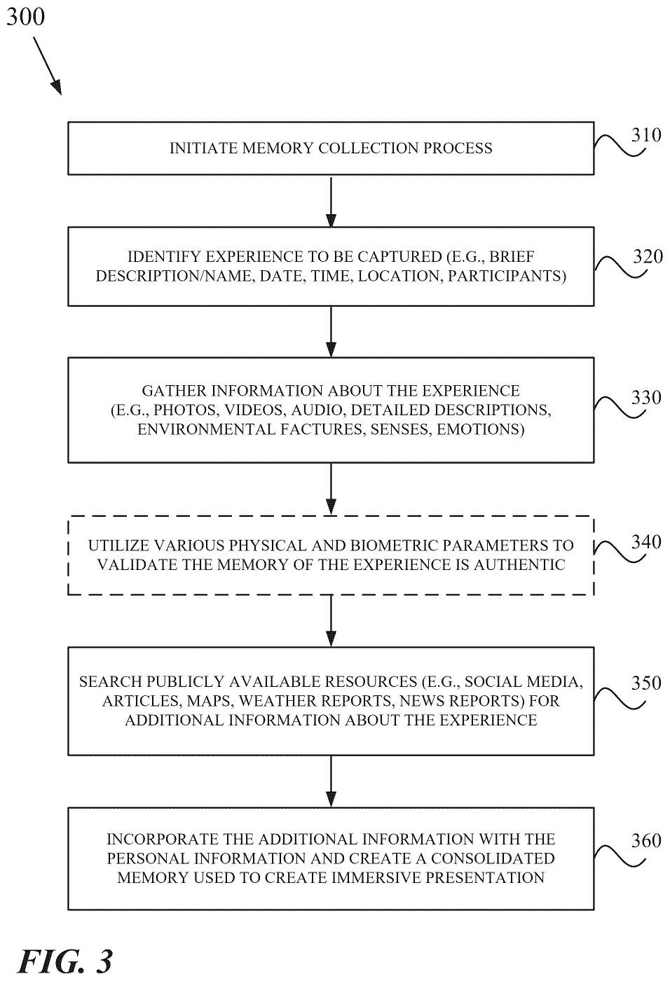

FIG. 3 illustrates a flow chart of an example process for capturing information related to an individual and their experience as it may relate to determining if they have the appropriate skills, competencies, innate traits, leadership, emotional intelligence, judgment, collaboration, and developmental trajectory 300. The process 300 starts when an individual or a human resource representative initiates a human resource (e.g., capability analysis) process 310. The human resource process may be initiated on a client device 130 (e.g., phone, tablet, laptop) by, for example, opening an appropriate app that communicates with the server 110. The client device 130 may be operated by the individual providing the answers and experience information or it may be operated by the HR representative collecting the information therefrom. The client device 130 may be utilized to collect answers to specific questions being asked including providing information about an experience that the individual has had that supports their answer. The experience may be from a previous job or other situation that shows the necessary skills, personality and the like for the position. The client device 130 may provide a user interface (UI), for example a graphical UI (GUI), that can be utilized to collect answers to questions including information about relative experiences.

Initially, the experience that information is being captured for is identified 320. The identifying includes annotating what question the experience is being provided for and capturing some general information about the experience including for example, a brief description (e.g., name), date, time, location, and participants that can be used for identification and indexing purposes. The UI may provide prompts for the general information needed to identify and index the experience. The UI may enable the information to be entered in various manners, including for example, entering via a keyboard or spoken into a microphone. According to one embodiment, it is possible the information is provided using brain machine interface technology.

Once the experience has been identified, detailed information about the experience is gathered 330. The detailed information gathered may include, but is not limited, to detailed descriptions (verbal and/or written), pictures, videos, audios, drawings and notes. The detailed descriptions may include, but is not limited, details related to the experience, location/venue, participants, environmental factors (e.g., temperature, humidity, precipitation, light, smell), personal factors (e.g., feelings, mood, emotions) and physical factors (e.g., touch, heart rate, perspiration, body temperature). The client device 130 may enable some of the information (e.g., videos, photos, audio, drawings, notes) to be uploaded.

Accessories may be utilized to capture certain information. The accessories may include, but are not limited to, microphones, scanners, recorders (video and/or audio), cameras, and various sensors. Some accessories may be part of the client device 130 (e.g., camera, microphone), some may be connectable to the client device 130 and enable information to be directly provided thereto, while others may be separate from the client device 130 and provide the information captured thereby to the client device 130 in some fashion (e.g., upload, enter, transmit).

The sensors may measure various biometric parameters including, but not limited to, temperature, pulse, heart rate, blood pressure, and sweat level. The biometric parameters captured may be used to infer emotions and/or feelings (sensory metadata) the individual may have experienced while recounting the experience (and these inferred feelings and physical parameters may have also been experienced when having the initial experience they are recounting).

According to one embodiment, the individual recounting the experience may be hooked up to different devices that may monitor brain waves. The brain waves may be used to interpret different parameters associated with recounting the memory (and presumably experienced during the initial experience). According to one embodiment, it is envisioned that future implementations may capture a real time snapshot of the brain's molecular and quantum states, decoding emotional signatures and visualized thoughts by analyzing the atomic and subatomic choreography of neural activity associated with the memory (neural data).

The devices may include, for example, a wired neural interface, a wireless brain-machine interface, a quantum brain interface, an energetic biofield interface, a bio-sensory neural interface and other future devices capable of capturing brain waves in some manner. Some of these devices are currently available while others are in development and/or are theoretical at this point. The wired neural interface includes neural implants in the individual and direct wiring to a computational device. It is envisioned that most individuals uploading information about their experiences will not be equipped with neural implants. The wireless brain-machine interface includes neural signals being transmitted wirelessly using electromagnetic fields. The quantum brain interface utilizes quantum entanglements and/or tunneling effects to facilitate real time communication between the brain and an advanced quantum computer. This may enable non-local interactions between the brain and computer. The energetic biofield interface is currently a speculative technology where the brain's biofield interacts with an external system to facilitate non-physical data exchange. The bio-sensory neural interface enables the brain's sensory inputs to directly interface with computational devices. In some embodiments, future implantable or non-invasive, non-contact BMI systems may leverage the proposition, and related theories, that consciousness involves quantum processes in neuronal microtubules, thereby enabling interaction with cognitive substrates at both classical and quantum levels for enhanced memory capture and restoration.

According to one embodiment, if the individual identifies others as being involved in the experience it is possible that information may be gathered from the other participants. Conflicting information may be flagged and presented to the individual to get an explanation as to whether there is a real conflict or not.

The biometric parameters, sensory metadata, neural data, and conflicting information in the case of experiences involving multiple parties may be utilized to determine a confidence level regarding the experience being accurate (individual actually participated in the experience they are describing) and if the individual has the appropriate skills, personality, temperament and the like for the position 340. That is, one or more of the various parameters may be compared to benchmark parameters to determine the likelihood that the information provided was real and accurate. The benchmark parameters may be for the general population, a portion of the population having similar traits (e.g., age, sex, race, ethnicity) to the individual, or for the individual. The benchmarks for the individual may be determined by using the sensors to capture the various parameters to known questions where it is known in advance if the individual is, for example, telling the truth, exaggerating, or lying. There may be benchmark parameters for various situations and the comparison of the various parameters needs to be performed based on the appropriate benchmarks. For example, a person's heart rate may spike when they are not telling the truth, but it may also spike if they are describing an exhilarating event.

The one or more of the various parameters may also be compared to benchmark parameters associated with different personality traits to determine what personality traits the individual has and if their personality traits are the personality traits desired or required for the position. The benchmark parameters may be for the general population or a portion of the population having similar traits (e.g., age, sex, race, ethnicity) to the individual. In certain embodiments, personality and related assessment data generated by the system may be retained, time-limited, or automatically destroyed according to configurable parameters, as described further herein, to comply with privacy, HR best practices, and applicable laws.

It should be noted that initially the details regarding the experience may be captured and after the details have been captured the experience may be identified for indexing, searching and the like (that is steps 330 and 340 could be switched without departing from the scope). The information used to identify the experience (e.g., brief description, date, time, location, participants) and possibly some additional information about the experience may be provided to the AI agent 140 in order to gather additional information about the experience from publicly available resources 350. The publicly available information may come from various sources including, but not limited to, social media, news reports, weather reports, maps, and publications. The publicly available information collected may include, but is not limited to, pictures or video of the experience, descriptions of the experience, and weather details for the day.

For example, if the experience involves decisions they made while they worked for a specific company at specific time, the AI agent 140 may find information about the company during that time frame. The information may include financial, technical, and business information for the company, the identify of others who worked for the company at that time specifically individuals who may have worked in the same group, division or the like. The additional information may be used to supplement, validate or contradict the information provided by the user.

According to one embodiment, additional information found by the AI agent 140 that appears to conflict with the information provided by the individual may be flagged. The conflicting information may be provided to the individual to get an explanation as to whether there is a real conflict or not.) may provide feedback in an attempt to resolve the discrepancies. For example, maybe the individual realizes that they provided the wrong date, time or the like for the experience so that the AI agent 140 gathered additional information that was not associated with the experience being described. The individual may correct the erroneous information they provided so that the AI agent 140 can gather accurate information.

The additional information gathered by the AI engine may be incorporated with the personal information gathered to create a consolidated experience that can be utilized to create an immersive presentation of the experience therefrom (immersive experience) 360. The consolidated experience may provide more complete descriptions and may provide a perspective not captured by the personal information. The consolidated experience may rearrange the order of the personal information provided or add additional items in the appropriate location.

The consolidated information may be presented to the individual as an immersive presentation. The immersive presentation may make someone interacting therewith feel like they are partaking in the experience. The extent of the immersive presentation may depend on the information provided/gathered, the service level signed up for and the type of device being utilized to experience the immersive presentation. According to one embodiment, the immersive presentation may be a video that may be presented on a display (e.g., phone, tablet, computer, television, wearable display glasses (smart glasses)). According to one embodiment, the immersive presentation may be a virtual reality (VR), augmented reality (AR) or mixed reality (MR) presentation of the experience. These immersive experiences may provide an individual experiencing the immersive presentation feel like they are actually part of the experience. The immersive presentation may include different sensations in addition to vision, including but not limited to, touch, smell, moisture, and temperature.

The immersive VR, AR or MR presentations may be designed to be used with AR or VR headsets. Alternatively, the immersive VR, AR or MR presentations may be designed to be used with systems that do not include headsets but rather mimic the experience by, for example, using specialized displays, non-contact VR, and possibly software running on standard displays. It is envisioned that in the future, the presentations may be designed to be experienced via direct-to-brain playback using various forms of contact and/or non-contact brain-machine interface technology, as well as other human-machine interface and interaction modalities, including, but not limited to, haptic, olfactory, thermal, and other sensory output systems.

The immersive presentations are not limited to being designed for any specific type or brand of equipment. Rather, they would be designed such that they can be used by various currently known technologies. Likewise, it is anticipated that they would be capable of easily adapting to any future technologies discovered. It is possible, as technology advances that some type of interface may be required to have the immersive presentations currently created be presented on these new technologies that may in future embodiments, for example, have the end-user experience the immersive memory presentation through contact or non-contact brain-machine interface technology, or other human-machine interaction systems designed to engage multiple senses such as touch, smell, taste, temperature, and motion.

The individual may review the consolidated experience as it is presented in the immersive presentation on the device available to them. As the individual reviews the immersive presentation they may be connected to various sensors to gather biometric parameters, sensory metadata, and/or neural data. This gathered data may be utilized to determine a confidence level regarding the experience being accurate (individual actually participated in the event they are describing). The gathered data may also be utilized to determine personality traits associated with the individual. The immersive experience may also be analyzed to determine personality traits associated with the individual.

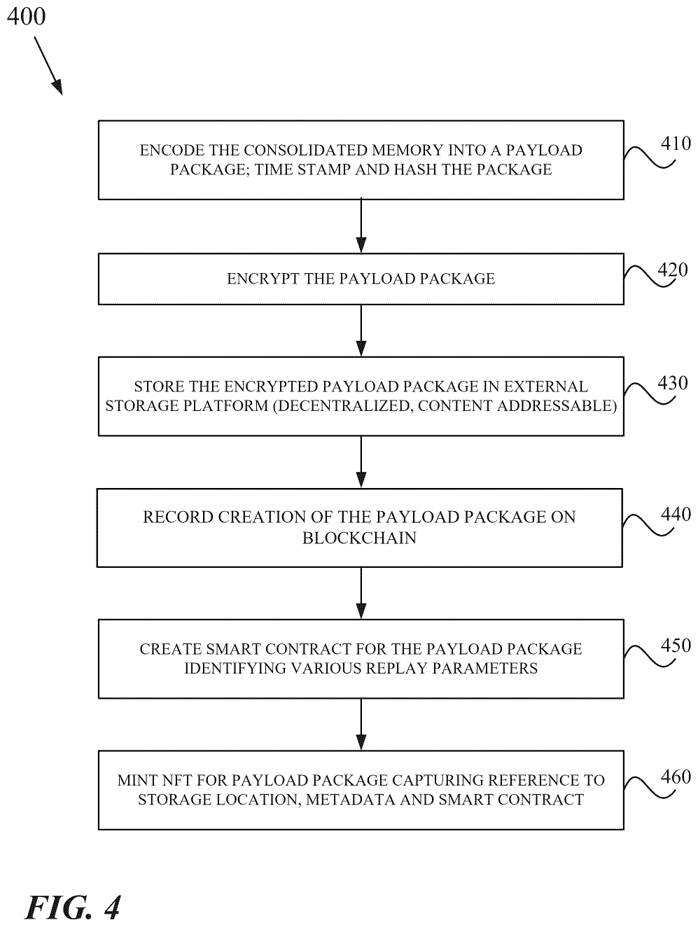

FIG. 4 illustrates a flow chart of an example process 400 for securely packaging the consolidated experience, securely storing the consolidated experience, creating ownership rights in the consolidated memory and controlling access thereto. Once the immersive presentation is complete all the information that makes up the immersive memory is encoded into a unified experience payload package 410. According to one embodiment, the information related to personality traits may also be included in the payload package. The package is time stamped and is cryptographically hashed using a hash key (e.g., SHA-256) and the hash value is stored in the payload. As one skilled in the art would know, the hash value is used to authenticate the validity of the data. Before the payload is used it will be cryptographically hashed and the hash value generated will be compared to the stored hash value. If the values are the same that payload is the same as it was when it was created (e.g., it has not been tampered with or corrupted). If the hash values are different the payload is not the same (e.g., has been tampered or corrupted).

The encoded payload is then encrypted using an algorithm and an encryption key (e.g., AES-256) to transform the payload into an unreadable format (ciphertext) 420. The cipher text is then stored on an external storage platform 430. The external storage platform may be a decentralized, content-addressable file system (e.g., Arweave, IPFS, Filecoin), encrypted cloud storage, or a proprietary secure memory vault. Each unified memory payload package is stored immutably and indexed via its unique hash and the unified resource identifier.

The creation of the unified experience payload package is recorded on the blockchain 440. A smart contract is created for the unified memory payload package, and the smart contract is recorded on the blockchain 450. The smart contract identifies, for example, ownership and access permissions. An NFT (nxNFT) is minted for the unified memory payload package based on an immutable reference to the unified memory payload package (e.g., external storage platform URI), metadata therefore and the smart contract logic 460. The metadata may include different parameters about the memory including, but not limited to, experience title, creator, timestamp, location, themes, personality traits and signature hash. The NFT is used to provide access to unified memory payload packages so that an immersive presentation can be experienced.

The immersive presentation may be viewed by others for various reasons as long as it meets organizational policy and applicable legal/regulatory requirements. For example, the immersive presentation may be reviewed by hiring managers as part of the hiring process. According to one embodiment, the immersive presentation may be reviewed by others who interact with the individual (employees, clients, customers, management) to provide them with an understanding of how the individual operates in certain situations. According to one embodiment, the immersive presentation may be used as a training tool for how to handle certain situations (or how not to handle).

A determination of whether the experience presented by the individual is authentic (is a Certified Experience) may be made as they provide details about the experience and their biometrics and/or neural data are collected, may be made after comparing their description of the experience with additional information gathered about the experience, may be made after the individual reviews the immersive presentation and their biometrics and/or neural data are collected, or a combination of all of that. The determination may be made in real time or may be made at a later time.

Likewise, the determination of the personality traits of the individual may be made as they provide details about the experience and their biometrics and/or neural data are collected, may be made after the individual reviews the immersive presentation and their biometrics and/or neural data are collected, may be made after the immersive experience is analyzed or a combination of all of that. The determination may be made in real time or may be made at a later time.

In certain embodiments, the personality and related assessment data generated during the immersive HR/talent management process may be stored in a secure, encrypted format as part of the employee or candidate's digital personnel file. This file may reside on the corporate side, the consulting company side, or both, with retention periods set according to need, organizational policy and applicable legal/regulatory requirements. Alternatively, the system can be configured to store such information only temporarily, using predetermined retention windows, time-delineated access, or self-destruct protocols, so that data is automatically and irretrievably deleted on a date-certain after the assessment and decision-making process is complete.

In all cases, data storage and retention parameters are configurable by the client and aligned with relevant privacy laws, HR best practices, and jurisdiction-specific rules governing employment records.

The system and process above have focused on human resource matters as they generally relate to hiring but are in no manner intended to be limited thereby. The system and process could also be utilized for executive coaching grounded in verifiable experience, ethical leadership modeling and culture repair through verified recollections, inclusion progress tracking via shared experience validation, detection of fraud or misrepresentation in resumes and interviews and of attempts to game existing assessment protocols, high-trust remote team formation and virtual onboarding, legally compliant hiring, firing, and promotion decisions with supporting documentation, and integration with law enforcement, insurance claims, and compliance systems requiring memory certification or behavioral traceability.

Although the disclosure has been illustrated by reference to specific embodiments, it will be apparent that the disclosure is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

1. A system to enable users to provide answers to questions and provide information about experiences they have had that support the answer, authenticate the experiences, generate a personality profile and create immersive presentations of the experiences as digital assets, the system comprising:
a processor; and
a computer readable medium instructions that when executed by the processor cause the processor to
present a user interface to an internet enabled device to enable the internet enabled device to answer questions and collect information about experiences that support the answer, wherein the information may be collected via text, audio or uploading, and wherein the information includes at least some subset of description of the experience; date, location, and environmental factors associated with the experience; and biometric parameters, sensory metadata, and neural data gathered from the user as the information is collected from the user;
utilize an artificial intelligence (AI) engine to gather publicly available information about the experience, consolidate the information collected from the user and the information gathered from the publicly available information, and create an immersive presentation of the memory of the experience;
validate the immersive presentation based on an analysis of some subset of biometric parameters, sensory metadata, and neural data gathered from the user and comparison of the information collected from the user and the information gathered from the publicly available information;
generate the personality profile based on at least some subset of the biometric parameters, sensory metadata, and neural data collected and the immersive presentation;
encode the consolidated information that makes up the immersive memory into a unified experience payload package that is time stamped and content addressable via cryptographic hash;
record creation of the unified experience payload package on a tamper-evident registry;
encrypt the unified experience payload package;
store the encrypted unified memory payload package in an external storage platform; and
mint a digital asset for the encrypted unified experience payload package including a smart contract that identifies parameters for the unified experience payload package including at least some subset of ownership and replay restrictions.

2. The system of claim 1, wherein the tamper-evident registry includes a blockchain or a distributed ledger.

3. The system of claim 1, wherein the tamper-evident registry includes a directed acyclic graph ledger, a quantum-secure distributed system, a federated consensus registry, or a trusted execution environment attestation log.

4. The system of claim 1, wherein the external storage platform includes a decentralized content-addressable file system, a decentralized encrypted cloud storage, or a decentralized secure memory vault.

5. The system of claim 1, wherein the digital asset is a non-fungible token.

6. The system of claim 1, wherein when the instructions are executed by the processor they further cause the processor to store the personality profile in a secure, encrypted format as part of the employee or candidate's digital personnel file.
